(19) United States
(12) Patent Application Publication
(10) Pub. No.: US 2026/0167127 A1
(43) Pub. Date: Jun. 18, 2026

(54) REINFORCEMENT STRUCTURE OF INSTRUMENT PANEL

(71) Applicant: TOYOTA JIDOSHA KABUSHIKI KAISHA, Toyota-shi (JP)

(72) Inventors: Kazunori TAKATA, Nisshin-shi (JP); Yoshiki TERADA, Nagoyo-shi (JP); Shizuo SANJO, Toyota-shi (JP); Shogo KAWASAKI, Toyota-shi. (JP); Hiroto GAMANO, Toyokawa-shi (JP)

(73) Assignee: TOYOTA JIDOSHA KABUSHIKI KAISHA, Toyota-shi (JP)

(21) Appl. No.: 19/377,008

(22) Filed: Nov. 2, 2025

(30) Foreign Application Priority Data
Dec. 18, 2024 (JP) 2024-221554

(51) Int. Cl. B60R 16/02; B60K 37/20

(52) U.S. Cl. CPC B60R 16/0215; B60K 37/20

(57) ABSTRACT

The reinforcement structure includes an embedding portion in which the wire harness is embedded and a cover portion surrounding the wire harness in cooperation with the embedding portion. The embedding portion includes a first rib extending along a longitudinal direction of the wire harness, a second rib extending along the longitudinal direction and approximately parallel to the first rib, a third rib extending along the longitudinal direction and disposed to be approximately orthogonal to the first rib and the second rib, and an intermediate rib intersecting the third rib, disposed to be approximately parallel to the first rib and the second rib, and having a smaller width from the third rib than widths from the first rib and the second rib. The wire harness is fixed between the intermediate rib and the cover portion.

### CROSS-REFERENCE TO RELATED APPLICATION

This application claims priority to Japanese Patent Application No. 2024-221554 filed on Dec. 18, 2024. The disclosure of the above-identified application, including the specification, drawings, and claims, is incorporated by reference herein in its entirety.

### BACKGROUND

### 1. Technical Field

The present disclosure relates to a reinforcement structure of an instrument panel.

### 2. Description of Related Art

In a vehicle, such as an automobile, an instrument panel is mounted in front of a driver's seat in the front area of the vehicle cabin. The instrument panel is made of a synthetic resin material and is mounted to a vehicle structure or a reinforcement.

In addition, a wire harness that constitutes wiring for connecting electrical equipment is provided in the vehicle. The wire harness is disposed on a back side of the instrument panel together with the reinforcement.

### SUMMARY

The reinforcement of the related art is made of a metal material, and thus an embedding portion for a wire harness is a pipe-shaped embedding portion having a circular cross section. Therefore, the wire harness constitutes a design constraint, a design constraint occurs in the instrument panel, a surface of the instrument panel is raised, and a mass of an entirety of the panel is also increased.

The present disclosure proposes a reinforcement structure of an instrument panel that can improve space efficiency and reduce design constraints of the instrument panel.

A reinforcement structure of an instrument panel according to an aspect of the present disclosure includes
an embedding portion in which a wire harness is embedded, and
a cover portion surrounding the wire harness in cooperation with the embedding portion.
The embedding portion includes a first rib extending along a longitudinal direction of the wire harness, a second rib extending along the longitudinal direction and substantially parallel to the first rib, a third rib extending along the longitudinal direction and disposed to be substantially orthogonal to the first rib and the second rib, and an intermediate rib intersecting the third rib, disposed to be substantially parallel to the first rib and the second rib, and having a smaller width from the third rib than a width of the first rib from the third rib and a width of the second rib from the third rib.
The wire harness is fixed between the intermediate rib and the cover portion.

According to the aspect, a cross-sectional shape of the embedding portion is a shape obtained by the first rib, the second rib, the third rib, and the intermediate rib, the shape being a shape resembling a combination of an E-shape and the rotated E-shape, and such a cross section extends along the longitudinal direction of the wire harness. Therefore, the wire harness can be embedded with a high space efficiency without wasting a cross-sectional space, and the design constraints of the instrument panel can be reduced.

In the reinforcement structure, the first rib and the second rib may each have a recessed portion that fits with the cover portion.

In addition, in the reinforcement structure, the embedding portion may have a curved shape that is curved in a front-rear direction in a longitudinal direction of the instrument panel. As a result, the wasted space in the instrument panel can be further reduced, and the design constraints can be reduced.

According to the present disclosure, it is possible to provide a reinforcement structure of an instrument panel that can improve space efficiency and reduce design constraints of the instrument panel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle instrument panel according to an embodiment;

FIG. 2 is a perspective view illustrating a structure of a reinforcement as a reinforcement member of a vehicle instrument panel and a wire harness embedded in the reinforcement;

FIG. 3 is a perspective view illustrating a structure of a reinforcement as a reinforcement member of a vehicle instrument panel and a wire harness embedded in the reinforcement according to an embodiment;

FIG. 4A is a front view illustrating an embedding portion of a reinforcement of a vehicle instrument panel according to an embodiment;

FIG. 4B is a cross-sectional view illustrating an embedding portion of a reinforcement of a vehicle instrument panel according to the embodiment;

FIG. 5A is a perspective view illustrating a structure of a cover portion and a reinforcement connected to the cover portion;

FIG. 5B is an enlarged perspective view of the cover portion;

FIG. 5C is a cross-sectional view illustrating a structure of a cover portion and a reinforcement connected to the cover portion; and

FIG. 6 is a perspective view and a cross-sectional view for describing the structure of the cover portion and the reinforcement connected to the cover portion.

### DETAILED DESCRIPTION OF EMBODIMENTS

Hereinafter, the present embodiment will be described with reference to the accompanying drawings. In the accompanying drawings, the same reference numerals may be used to denote the same elements. Although the accompanying drawings show the embodiment and the implementation example according to the principle of the present disclosure, the drawings are for understanding the present disclosure and are not used to interpret the present disclosure in a limit manner. The description of the present specification is merely a typical example, and the scope of the claims or the application examples of the present disclosure are not limited in any way.

In the present embodiment, the description is made in sufficient detail for the person skilled in the art to carry out the present disclosure. However, other implementations and embodiments are also possible, and it is needed to understand that the configuration and structure can be changed and various elements can be replaced without departing from the scope and spirit of the technical idea of the present disclosure. Therefore, the following description should not be interpreted as being limited thereto.

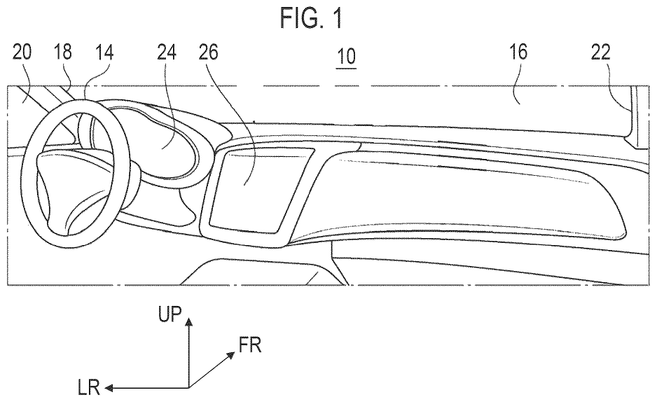

Hereinafter, a vehicle instrument panel 10 (hereinafter, referred to as a “vehicle instrument panel 10”) according to an embodiment will be described using FIG. 1. In addition, an arrow FR, an arrow UP, and an arrow LR shown in each of the drawings indicate a front side, an upper side, and a right-left direction (width direction) of the vehicle including the vehicle instrument panel 10, respectively.

As shown in FIG. 1, the vehicle instrument panel 10 extends in an approximately vehicle width direction at a front portion of a vehicle cabin inside the vehicle. A steering wheel 14 is provided behind the vehicle instrument panel 10. The steering wheel 14 is provided on the left side of the vehicle as an example in FIG. 1 (left steering wheel). The vehicle is not limited to a left steering wheel vehicle, and may be a right-hand drive vehicle in which a driver's seat is set on the right side.

The vehicle instrument panel 10 is disposed below a windshield glass 16 of the vehicle. The windshield glass 16 is inclined at a downward gradient toward a front side of the vehicle, and partitions the inside of the vehicle cabin and the outside of the vehicle cabin.

A left end portion of the windshield glass 16 is fixed to an inside of a vehicle width direction of a front pillar 18 on a left side of the vehicle, which extends in an approximately vertical direction. In addition, a front side window 20 provided on a left side of a vehicle 12 is provided to the rear of the front pillar 18 in the vehicle. Similarly, the right end portion of the windshield glass 16 is fixed to a front pillar 22 on the right side of the vehicle, and a front side window (not shown) is provided to the rear of the front pillar 22 in the vehicle. A meter display 24 is provided in front of the vehicle and above the instrument panel 10 of the driver's seat. In addition, in the instrument panel 10, a center display 26 is provided at the center portion in the vehicle width direction.

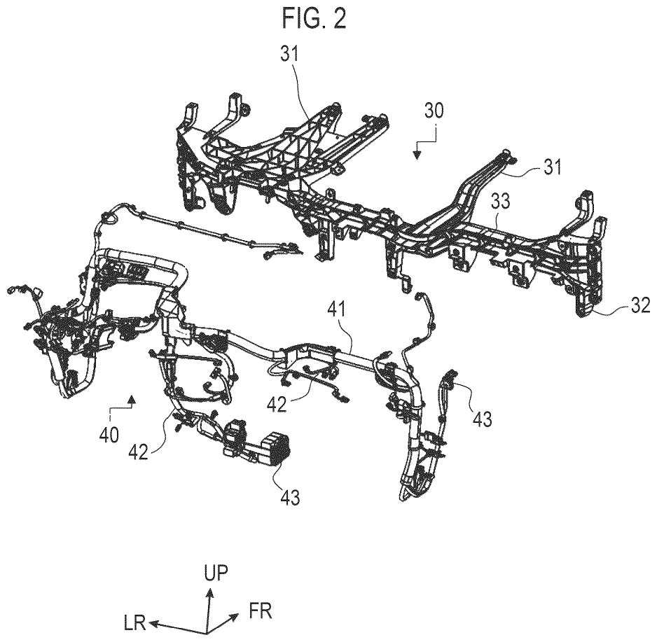

With reference to FIG. 2, a structure of the reinforcement member as a reinforcement 30 of the vehicle instrument panel 10 and a wire harness 40 embedded in the reinforcement 30 will be described. The reinforcement 30 is fixed to a dash panel of a vehicle body (not shown) to reinforce the vehicle instrument panel 10 and supports the vehicle instrument panel 10. The reinforcement 30 of the present embodiment can be made of a synthetic resin material, such as polypropylene, polyethylene, or ABS. As an example, a bracket 31 that supports the vehicle instrument panel 10, a fixed portion 32 that is fixed to the dash panel, and an embedding portion 33 that embeds the wire harness 40 are provided.

The fixed portion 32 is provided with a bolt hole (not shown) in FIG. 2, and the reinforcement 30 can be fixed to the body of the vehicle by screwing a bolt into the bolt hole. The embedding portion 33 provides a space for embedding the wire harness 40, and a cover portion 50 to be described later is connected to the embedding portion 33, so that the wire harness 40 can be embedded in the space surrounded by the embedding portion 33 and the cover portion.

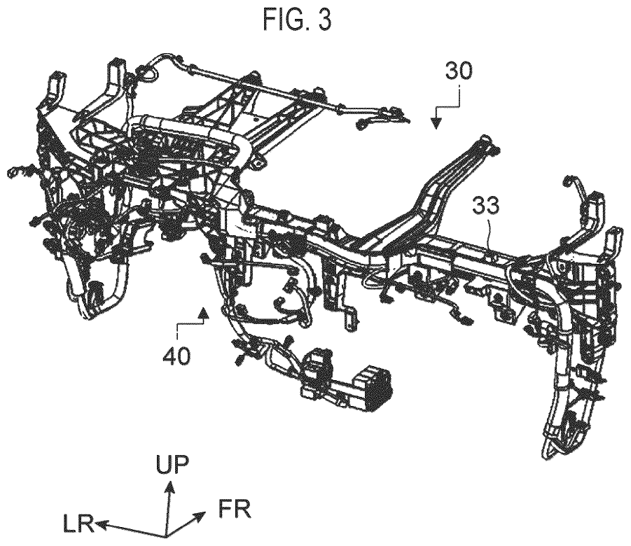

The wire harness 40 is a housing that holds the electric wires connected to various electrical components in the vehicle, and includes an electric wire portion 41, a branch portion 42, a connector 43, and the like. The electric wire portion 41 is configured by binding a plurality of electric wires with a binding member. The branch portion 42 is configured by a wire branching from the electric wire portion 41. The connector 43 is a connection portion for connecting various electric wires to various electrical components (not shown). The wire harness 40 configured as shown in FIG. 2 is embedded in the embedding portion 33 having a curved shape that is curved in the front-rear direction along the curved shape of the electric wire portion 41 of the wire harness 40 in the longitudinal direction of the vehicle instrument panel 10 (see FIG. 3). Then, the cover portion 50 to be described later is mounted in a part, and thus the cover portion 50 is fixed to the embedding portion 33. In the example of FIG. 1, the center display 26 is disposed at the center of the vehicle instrument panel 10. On the other hand, the steering wheel 14 is disposed on the left side. Therefore, the reinforcement 30 is configured such that a portion corresponding to the steering wheel 14 is curved forward (toward the vehicle front end side), and a portion corresponding to the center display 26 is curved rearward (toward the vehicle cabin side). The embedding portion 33 is curved to match the shape of the wire harness 40 and has a shape described below, so that the space efficiency is improved and the design constraints of the vehicle instrument panel 10 are reduced, and the wire harness 40 can be accommodated.

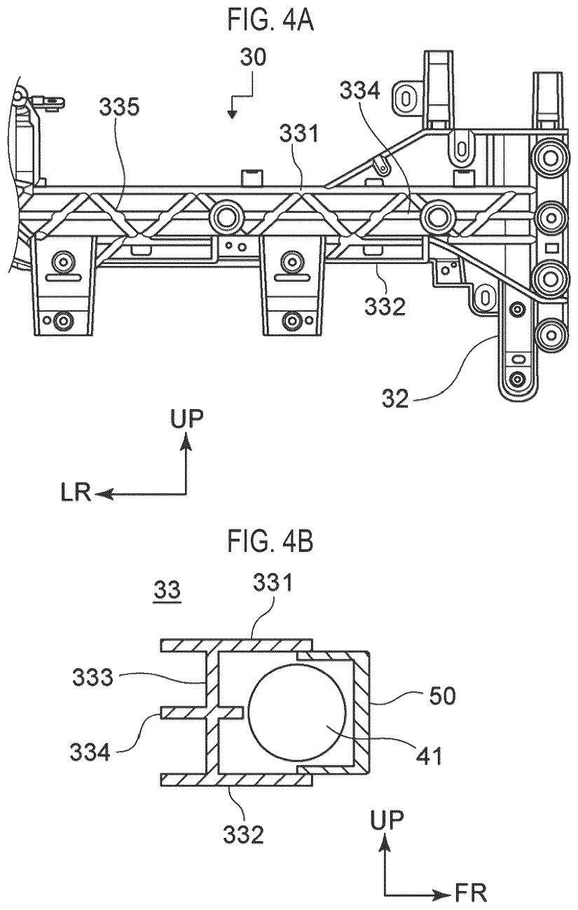

The structure of the embedding portion 33 of the reinforcement 30 will be described with reference to FIGS. 4A and 4B. FIG. 4A is a front view of the embedding portion 33 of the reinforcement 30 as viewed from the front, and FIG. 4B is a cross-sectional view of the embedding portion 33. The reinforcement 30 can be made using, for example, a 3D printer using a synthetic resin as a material. The embedding portion 33 includes, for example, a first rib 331, a second rib 332, a third rib 333, and an intermediate rib 334.

The first rib 331 and the second rib 332 constitute an upper wall and a lower wall of the embedding portion 33, and are plate-shaped members that are approximately parallel to each other and extend along the longitudinal direction of the wire harness 40. Since the wire harness 40 has a curved shape, the first rib 331 and the second rib 332 also have the same curved shape at corresponding portions.

The third rib 333 is a plate-shaped member that constitutes the rear wall of the embedding portion 33, and extends along the longitudinal direction of the wire harness 40, similarly to the first rib 331 and the second rib 332. Note that the third rib 333 is disposed to have a wall surface that is approximately orthogonal to the first rib 331 and the second rib 332. It is preferable that the third rib 333 is provided at a position slightly closer to the front side of the vehicle than the intermediate portion of the first rib 331 and the second rib 332.

The intermediate rib 334 is provided to intersect the third rib 333 and to be approximately parallel to the first rib 331 and the second rib 332. As shown in FIG. 4B, the intermediate rib 334 has a position of the front end portion thereof that is located more on the back side than the position of the front end portion of the first rib 331 and the second rib 332. That is, the intermediate rib 334 has a smaller width from the third rib 333 than the widths from the first rib 331 and the second rib 332. As a result, the embedding portion 33 can embed the electric wire portion 41 of the wire harness 40 in the space provided by the difference in width.

As shown in FIG. 4A, the embedding portion 33 includes a reinforcing rib 335 that is disposed to intersect the intermediate rib 334 in a zigzag shape in addition to the first rib 331, the third rib 333, and the intermediate rib 334. The reinforcing rib 335 has a horizontal width larger than the intermediate rib 334.

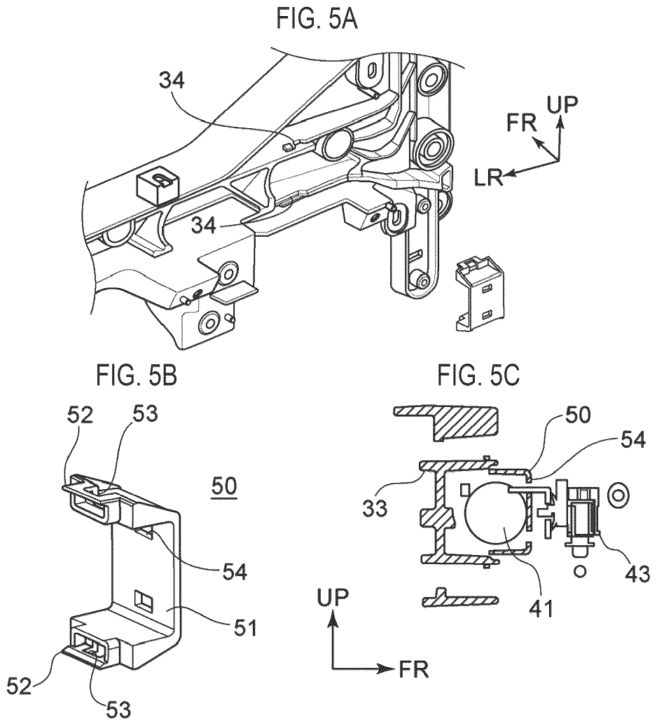

A structure of the cover portion 50 and the reinforcement 30 to which the cover portion 50 is connected will be described with reference to FIGS. 5A to 5C. FIG. 5A is a perspective view illustrating the structure of the cover portion 50 and the reinforcement 30, FIG. 5B is an enlarged perspective view of the cover portion 50, and FIG. 5C is a cross-sectional view. The reinforcement 30 has a cutout portion 34 (recessed portion) for fitting the cover portion 50 in a part of the embedding portion 33. The cutout portion 34 is a portion in which the end portions of the first rib 331 and the second rib 332 are recessed in the horizontal direction. Although not shown, a fitting hole of a fitting portion to be described later is fitted to the surfaces of the first rib 331 and the second rib 332 near the top of the cutout portion 34, and a fitting claw for fixing the cover portion 50 is provided.

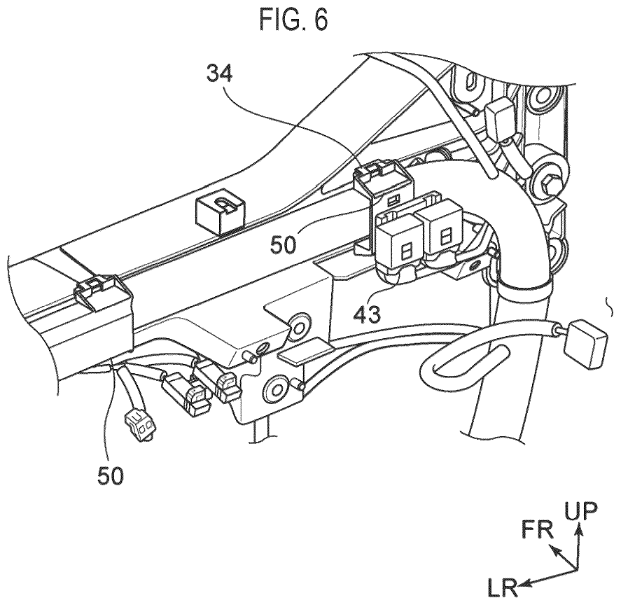

The cover portion 50 includes, for example, a main body 51, a fitting portion 52 that extends to be approximately orthogonal to the main body 51, a fitting hole 53 provided near a tip end of the fitting portion 52, and a fixing hole 54 for fixing the connector 43. The fitting hole 53 is fitted with the fitting claw described above, so that the cover portion 50 can be fixed to the embedding portion 33 of the reinforcement 30. Further, as shown in FIG. 5C, the connector 43 can be connected through the fixing hole 54 and the connector 43 can be fixed to the reinforcement 30. As shown in FIG. 6, the cover portion 50 can be used in combination with a cover portion having the fixing hole 54 for fixing the connector 43 and a cover portion not having the fixing hole 54. The branch portions 42 of the wire harness 40 are preferably disposed concentratedly on the cover portion 50 or a portion other than the embedding portion 33.

As described above, according to the present embodiment, the embedding portion 33 for embedding the wire harness 40 of the reinforcement 30 has a shape obtained by the first rib to the third rib, and the intermediate rib, the shape serving as a shape resembling a combination of an E-shape and the rotated E-shape. As a result, it is possible to provide the reinforcement structure of the instrument panel that can improve the space efficiency of the housing portion of the wire harness 40 and reduce the design constraints of the instrument panel. Since a protector or a protective material is also not needed, cost can be reduced, and the mass of an entirety of panel can be reduced.

### Others

The present disclosure is not limited to the embodiments, and various modifications are included. For example, the embodiments are described in detail in order to facilitate the understanding of the present disclosure, and are not invariably limited to including all the configurations described. In addition, a part of the configuration of one embodiment can be replaced with the configuration of another embodiment, and the configuration of another embodiment can be added to the configuration of one embodiment. In addition, a part of the configuration of each embodiment can be added, deleted, or replaced with another configuration.

What is claimed is:

1. A reinforcement structure of an instrument panel, the reinforcement structure comprising:
an embedding portion in which a wire harness is embedded; and
a cover portion surrounding the wire harness in cooperation with the embedding portion,
wherein the embedding portion includes a first rib extending along a longitudinal direction of the wire harness, a second rib extending along the longitudinal direction and substantially parallel to the first rib, a third rib extending along the longitudinal direction and disposed to be substantially orthogonal to the first rib and the second rib, and an intermediate rib intersecting the third rib, substantially parallel to the first rib and the second rib, and having a smaller width from the third rib than a width of the first rib from the third rib and a width of the second rib from the third rib, and
wherein the wire harness is fixed between the intermediate rib and the cover portion.

2. The reinforcement structure according to claim 1, wherein the first rib and the second rib each have a recessed portion that fits with the cover portion.

3. The reinforcement structure according to claim 1, wherein the embedding portion has a curved shape that is curved in a front-rear direction in a longitudinal direction of the instrument panel.

4. The reinforcement structure according to claim 1, wherein the cover portion is configured to be able to fix a connector of the wire harness.
